(19) United States
(12) Patent Application Publication
(10) Pub. No.: US 2010/0088588 A1
(43) Pub. Date: Apr. 8, 2010

(54) METHOD AND DEVICE FOR PROCESSING DOCUMENTS ON THE BASIS OF ENRICHED SCHEMAS AND CORRESPONDING DECODING METHOD AND DEVICE

(75) Inventor: Youenn Fablet, La Roulais (FR)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/522,577

(22) PCT Filed: Jan. 9, 2008
(86) PCT No.: PCT/IB2008/001541

§ 371 Date: Jul. 9, 2009

(30) Foreign Application Priority Data
Jan. 9, 2007 (FR) 0752590

(51) Int. Cl. G06F 17/00

(52) U.S. Cl. 715/234

(57) ABSTRACT

This application proposes an enrichment to XML component-based languages, such as WSDL, Relax NG. This enrichment is based on a schema extension for expressing links. Two types of links are distinguished, those to another components (enrichment links) and those to particular entities (simple links). This additional information provides improved binary conversion based on pointers for the first type and string identifiers for the second type, and easier extractions of self-describing sub-documents.

The present invention concerns a method and a device for processing documents on the basis of enriched document schemas and a corresponding decoding method and device. It applies, in particular, to the processing of documents described in language complying with the “XML” standard (XML being an acronym for “extended markup language”).

XML is a standard which makes it possible to represent data in text form. These data are organized hierarchically in the form of trees. The XML processing entities, named “parsers”, provide access to the data of the XML document via that tree structure.

There are different types of XML parser. The DOM (acronym for “Document Object Model”) constructs the whole of the tree in memory and enables the user to navigate through that tree. The tree is composed of XML nodes. The main disadvantage of this model is that it is memory-hungry and requires retrieval of the whole of the XML document before starting to process it.

To solve these problems, other parser models have been created. The main alternatives to the DOM are the SAX and PULL models. These two models have in common the fact of not constructing the whole of the tree in memory. Such a parser navigates in the XML tree going from XML node to XML node using a “depth-first” algorithm. It only keeps in memory the current node of the XML tree. An XML node, in this case, may in particular correspond to an opening XML element, a closing XML element, a text element, for example. In the following example, the XML fragment contains three nodes: an opening element, a text node and a closing node.

<ns:example attribute=’value’>
Textnode
</ns:example>

Among the types of XML node may be found: opening element, closing element, text, comment, CDATA section (data in C language), DTD section (DTD being an acronym for “document type definition”), and processing instruction.

The XML parser breaks down each node into a set of items (the exact set of the items depending upon the exact implementation of the parser), represented in string form. Going back to the example above, the first node (opening element) may be separated into four items: ‘ns’ (or ‘ns:example’), ‘example’, ‘attribute’ and ‘value’; the second node is represented as a single item: ‘TextNode’; the third node as two items: ‘ns’ (or ‘ns:example’ according to the exact implementation of the parser) and ‘example’. Each item has a particular function and is rendered accessible by the parser via a particular API (acronym for “application programming interface”).

In the case of SAX for example, the SAX parser calls functions implemented by the application and that are specialized for each type of node. If the example given above is returned to, the SAX parser will call in this order:
a function of “STARTTAG” type which will have as parameter the local name of the element (here ‘example’), its qualified name (here ‘ns:example’), a list of attributes (here a single attribute named ‘attribute’ and of value ‘value’),
a function of “TEXTNODE” type which will have as parameter the value of the text node (here ‘Textnode’) and
a function of “ENDTAG” type, which will have as parameter(s), the local name of the element (here ‘example’) and its qualified name (here ‘ns:example’).

The application may then make use of each item, passed by the parser, into parameters of the functions, to process the data.

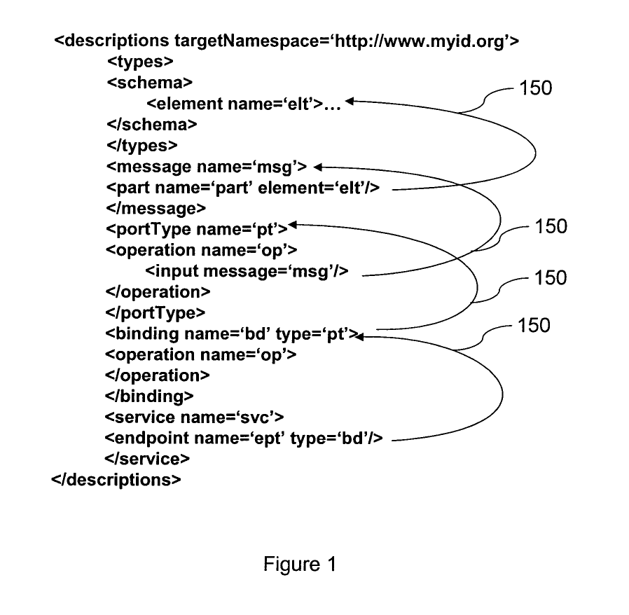

XML is used as a base for certain languages such as “WSDL” (acronym for “Web Services Description Language” which may be found at the following address: http://www.w3.org/TR/wsdl), “XML Schema” or “Relax NG” (acronym for “REgular LAnguage for XML Next Generation”), which are XML standards developed by the W3C and/or the ISO which describe components. These languages define different types of components. These components are described as XML elements within an XML document. The identifier of a component, called “qualified name” of a component, corresponds to the name of the component associated with an identifier which is global to all the components of the document. A component is identified uniquely by its qualified name also termed “QName” and by its type. These identifiers are in particular used to link two components, as illustrated by arrows 150 in the example given in FIG. 1.

The languages which describe components, connected to each other by the mechanism of qualified names, generally have a schema. This schema ambiguously identifies the parts of a component able to be references to components. This is because any part of a component having the type “QName” may be such a reference. However, the use of the qualified names is not limited to making references to other components. Qualified names may also be used to link a component to a particular semantic. For example, SOAP (acronym for “Simple Object Access Protocol”) 1.2 defining a certain number of qualified names to describe different types of SOAP faults, these qualified names may be found in WSDL documents which use referencing by qualified name.

It is to be noted that certain languages enable the creation of references directly from an “NCName”. It is to be recalled that a QName has a NameSpace and a name which correspond to an NCName, the NameSpace of the reference being either implicit, or being given in another part of the component. In the following portion of the description of the present invention, in relation to the problems that it solves and of its advantages, reference mechanism is referred to by “QName” or “qualified name”, this designation also covering the case of reference by “NCName”.

When an XML document server processes a document which uses referencing by name, several problems arise concurrently:
the names are coded as strings in most binary formats. These names must be resolved, whether the XML is binary or not, by the conventional mechanism which is not efficient (comparison of strings) and
the document must be transmitted as a whole: a subset of the XML document cannot be selected by the server given the risk of losing a part of the components necessary for the processing.

It is possible to define references that a computer may process, via the “ID” and “IDREF” types. An element “A” may be referenced by an element “B” if the element “A” has an attribute or a text node of “ID” type and if the element “B” has an attribute or text node of type “IDREF”. However, it is to be noted that this mechanism does not enable references to other documents to be made. If a reference is missing in the document, that document is invalid and cannot be processed, which is not the case with the qualified name mechanism. Furthermore, an identifier is uniquely associated with a component, whereas the same qualified name may be used to reference different components (it is the “type and qualified name” association which is unique, the type being described in the specification). For all these reasons, but also for reasons of practicality, numerous languages use qualified names while the mechanism by ID is little used.

For these languages, for example WSDL, XML Schema or Relax NG, which define references not using the ID/IDREF mechanism, it is not possible to determine whether a value (attribute or text node) corresponds to a reference or not, and if yes, how to retrieve the component on the basis of the reference.

The present invention aims to remedy these drawbacks.

To that end, a first aspect of the present invention concerns a method of processing documents in a computer system, which comprises:
a prior step of enriching a schema of the document to separate qualified names used to reference components and qualified names used to reference defined semantics and
a step of detecting components referenced in the document using the enriched schema obtained in advance.

By virtue of these provisions, the information for classification of the names and for location of the components is known by the applications, which enables them to optimize the processing and the transmission of such documents:
when a user wishes to retrieve only a single component, he is currently obliged to retrieve the whole of the document whereas with the implementation of the present invention, he only retrieves the subset of the document containing the component searched for and the set of the components pointed to by that component and
at the time of the binary coding of such a document, the name used to reference the component may be directly coded as a reference, in the form of a particular mechanism (index, pointer). This enables better compression and better processing of the qualified name.

It is noted that the implementation of the present invention may, in particular, serve for two purposes:
more efficient binary coding of the document and
selecting a self-descriptive subset of components

According to particular features, the method as succinctly set forth above further comprises a step of adding information to the schema in order to detect, in the case of references to components, the position of the components referenced in the document.

This makes it possible to further increase the rapidity of processing the documents using qualified names.

According to particular features, the method as succinctly set forth above comprises a step of sending a request during which a client sends the name of at least one component to retrieve and/or the name of the document to the computer system.

The invention is advantageously applicable with a local or remote computer system.

According to particular features, on reception of said request, and until a self-descriptive set of components is obtained, said computer system iteratively performs:
a step of retrieving the description of the component searched for and the set of the references of that component, said references being determined according to the schema of the enriched document and
a step of retrieving a description of each referenced component.

During this last step, the computer system may know that some components are already known by the client who sent the request, in which case, the referenced component may be processed like the external references, so making it possible not to send those components several times.

According to particular features, said computer system furthermore performs, after at least one said iterative step, a step of coding the description of at least one component in extended markup language, which may be binary.

According to particular features, the method as succinctly set forth above comprises a step of coding in binary extended markup language, during which the qualified names of reference type are coded as a pointer to another component.

According to particular features, during the coding step, said pointer is coded in the form of a position in the data stream expressed in bit form.

According to particular features, during the coding step, said pointer is coded in the form of a position of the component in a list.

The advantages of each of these provisions are double: more efficient coding of the information is enabled (fewer bits to transmit) and more efficient processing of the components is also enabled by facilitating the resolution of those references.

According to particular features, during the coding step, an item of information of enrichment link type is implemented to compress the referencing component on the basis of the referenced component.

According to particular features, during the coding step, the qualified names of at least one type other than the reference type are coded by separating a local name from the prefix by a namespace.

According to particular features, the method as succinctly set forth above further comprises a step of adding an extension schema to the computer system.

According to particular features, during the step of enriching the document schema, addition is made to the document schema, at the level of the definition of a root element of the language, of:
what a component is,
where the inclusion mechanisms and their associated namespace are,

where the namespace URI is of the document,
if it is a reference, its type and its target.

According to a second aspect, the present invention concerns a device for processing documents, which comprises:
a means for enriching a schema of the document to separate qualified names used to reference components and qualified names used to reference defined semantics;
a means for adding information to the schema in order to detect, in the case of references to components, the position of the components referenced in the document.

According to a third aspect, the present invention concerns a decoding method which for each component of a data stream comprises:
a step of determining whether the information of the component contains a reference to a component that has not yet been processed,
if the information of the component contains a reference to a component that has not yet been processed, a step of determining whether it is an internal reference,
if it is an external reference, a step of using the link information to retrieve the data stream and the location in the data stream containing the information of that component and
if it is an internal reference, a step of using the link information to access the information of the referenced component in the same data stream.

According to a fourth aspect, the present invention concerns a decoding device, which comprises:
a means for determining whether the information of each component contains a reference to a component that has not yet been processed,
a determining means which, if the information of the component contains a reference to a component that has not yet been processed, is adapted to determine whether it is an internal reference,
a using means which, if it is an external reference, is adapted to use the link information to retrieve the data stream and the location in the data stream containing the information of that component and, if it is an internal reference, is adapted to use the link information to access the information of the referenced component in the same data stream.

According to a fifth aspect, the present invention concerns a computer program loadable into a computer system, said program containing instructions enabling the implementation of the processing method and/or of the decoding method as succinctly set forth above, when that program is loaded and executed by a computer system.

According to a sixth aspect, the present invention concerns an information carrier readable by a computer or a microprocessor, removable or not, storing instructions of a computer program, characterized in that it enables the implementation of the processing method and/or of the decoding method as succinctly set forth above when that program is loaded and executed by a computer program.

As the advantages, objectives and particular features of this processing device, of this decoding method and device, of this computer program and of this information carrier are similar to those of the method as succinctly set forth above, they are not repeated here.

Other advantages, objects and particular features of the present invention will emerge from the following description, given, with an explanatory purpose that is in no way limiting, with respect to the accompanying drawings, in which:

FIG. 1 represents components provided with identifiers, as is known in the prior art,

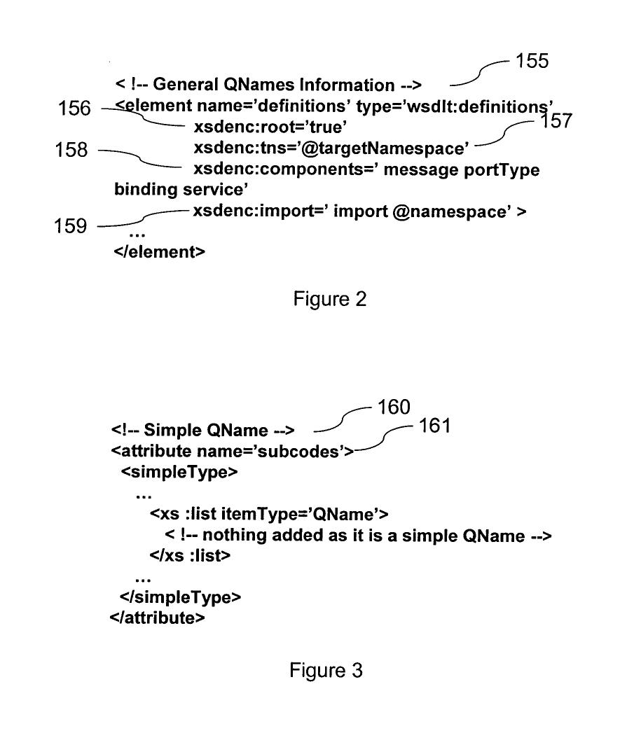

FIGS. 2 to 5 represent lines of codes implementing the present invention,

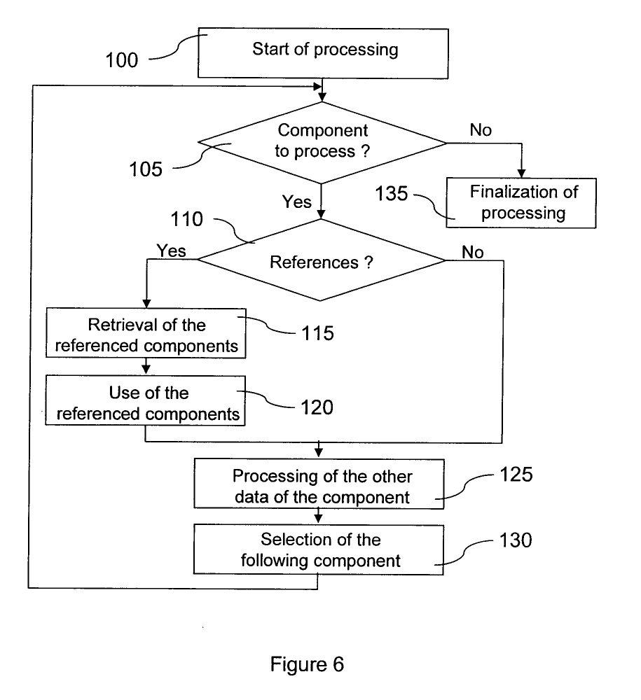

FIG. 6 is a representation in the form of a logigram of the steps implemented in a first embodiment of the method of the present invention implementing link information,

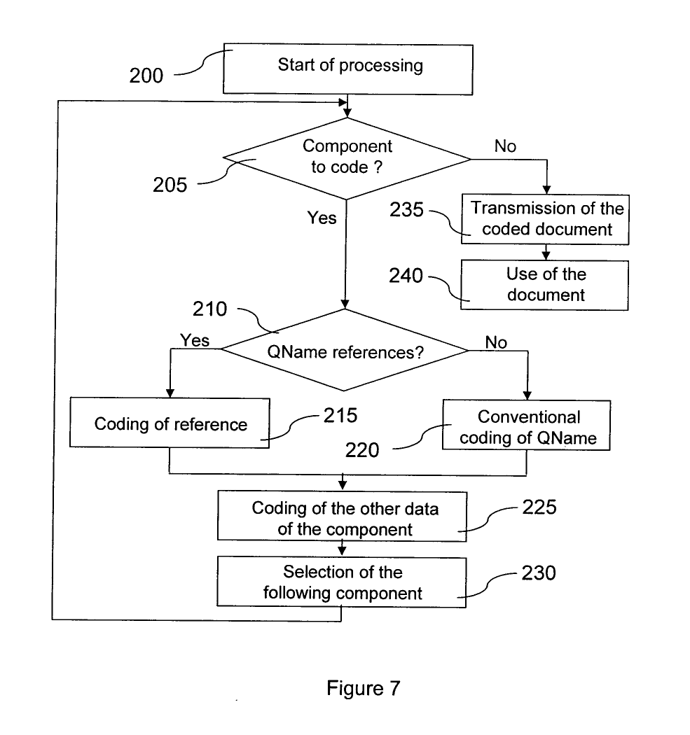

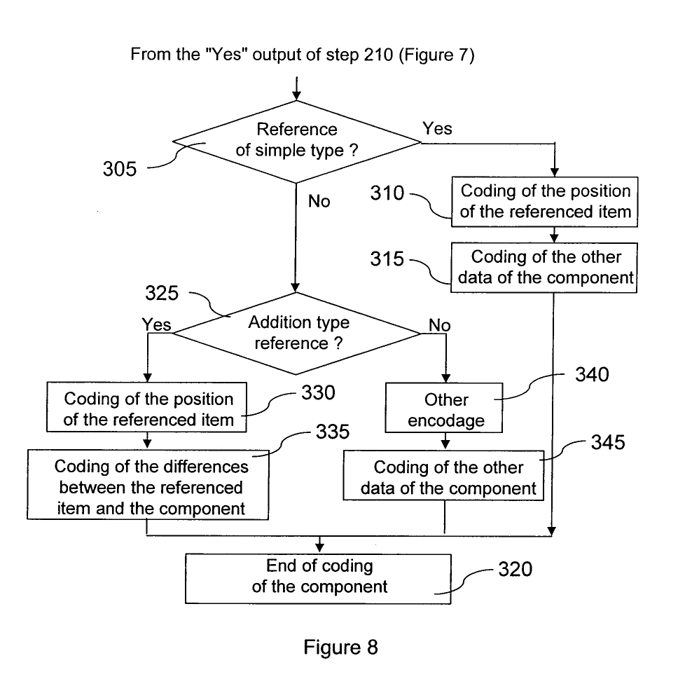

FIG. 7 represents, in logigram form, steps implemented in a second embodiment of the method of the present invention, applied to a coding operation;

FIG. 8 represents, in logigram form, sub-steps of steps illustrated in FIG. 7,

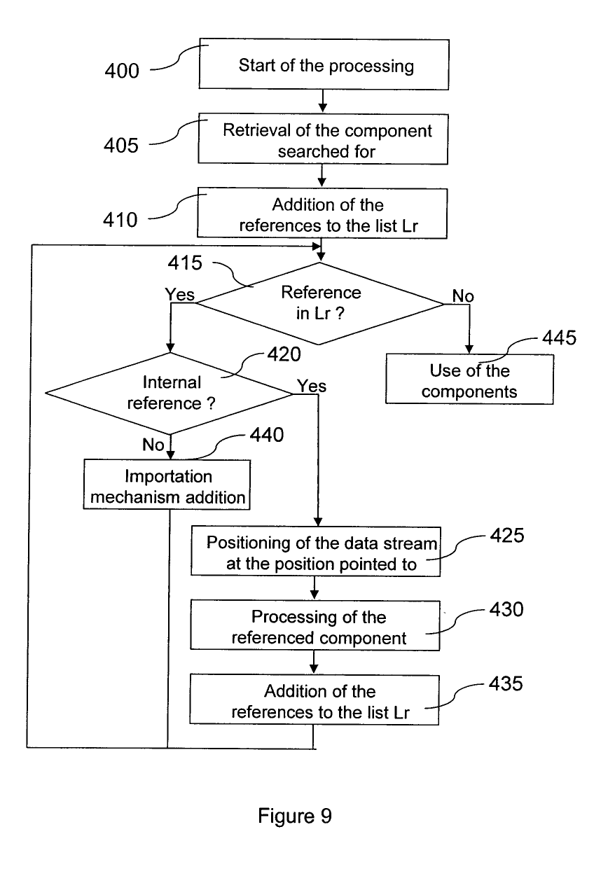

FIG. 9 represents, in logigram form, steps of a selection of a self-descriptive subset of components implemented in particular embodiments of the method of the present invention,

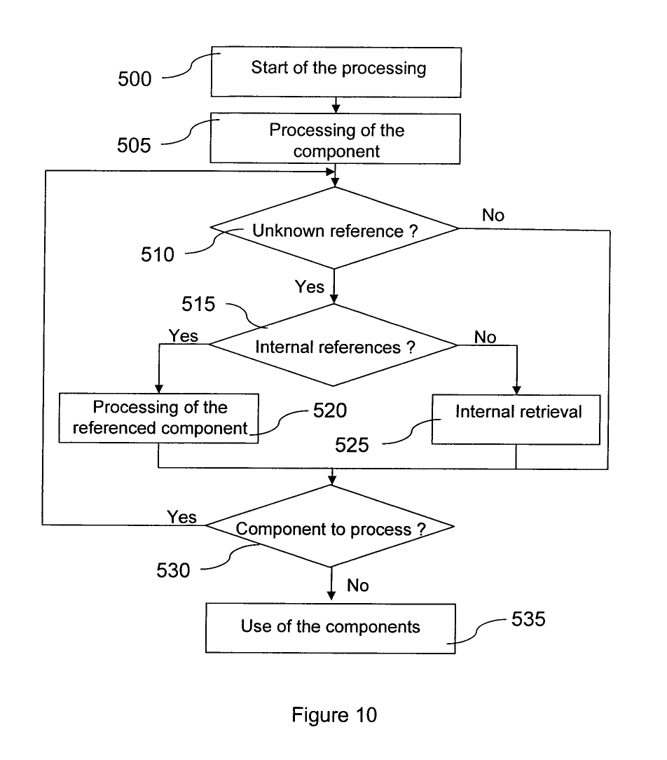

FIG. 10 represents, in logigram form, steps implemented in an embodiment of the method of the present invention, applied to a decoding operation and

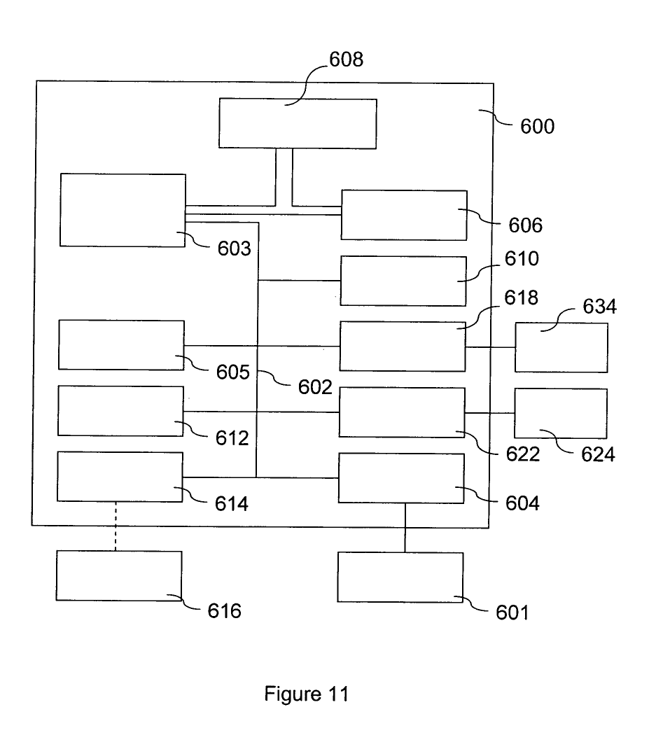

FIG. 11 is a diagram of a particular embodiment of the device of the present invention.

In the description, the presentation of the invention has been restricted to the cases of the XML languages having an identifier of a component, termed “qualified name” of a component, which corresponds to the name of the component associated with an identifier which is global to all the components of the document. A component is identified uniquely by its qualified name also termed “QName” and by its type. These identifiers are in particular used to link two components, as illustrated in the example given in FIG. 1. This concerns in particular the languages “WSDL”, “XML Schema” and “Relax NG”.

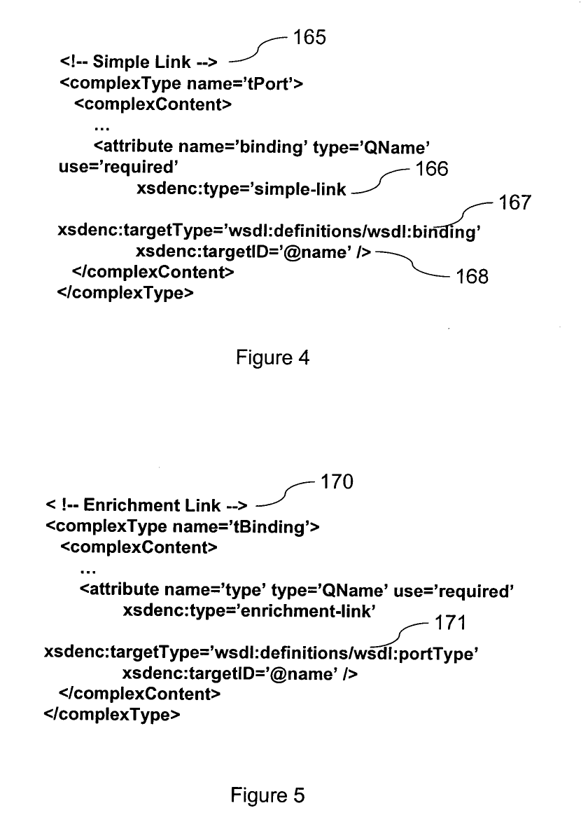

The method of the present invention consists of enriching the schema of the document to separate the qualified names used to reference components (see FIGS. 4 and 5) and the qualified names used to reference defined semantics (see FIG. 3). Furthermore, information is added to the schema which, in the case of references to components, makes it possible to detect the position of the components referenced in the XML document (see FIG. 2).

The method of the present invention may, in particular, be used for two purposes:
the more efficient binary coding of the document, as set forth with respect to FIGS. 7 and 8, and
the selection of a self-descriptive subset of components, as set forth with respect to FIG. 9.

It is thus possible to have a system which can process several types of document without needing to modify the program of the system, provided that a sufficient set of information is given to that system.

As regards the link information, the items of information to provide by the system to implement an embodiment of the method of the present invention are:
what a component is,
where the inclusion mechanisms and their associated namespace are,
where the namespace URI is of the document and
for each use of the qualified name type, specifying whether it concerns a reference, its type and its target (see FIGS. 3 to 5).

For the first three items of information, these may be added at the level of the definition of the root element of the language. For XML Schema, this may give what is described in FIG. 2. FIG. 2 corresponds to an XML Schema description 155 of a “definitions” element. This description is enriched with items of information 156 to 159 enabling the detection and the resolution of the references: the attribute 156 “xsdenc:root” presents the element “definitions” as a root element; the attribute 157 “xsdenc:tns” makes it possible to retrieve the namespace associated with the set of the child components of that root node; the attribute 158 “xsdenc:components” corresponds to the list of the types of component of the root element and the attribute 159 “xsdenc:import” makes it possible to locate the elements enabling the external references.

FIG. 3 represents a schema example 160 using qualified names. More particularly, the example describes an attribute 161 named “subcodes” of which the type is a QName list. As no annotation has been added to the definition of this attribute, the latter does not contain any reference to a component.

FIG. 4 represents an example 165 of annotation to specify that a use of qualified name is of component reference type. The example describes an attribute, named “binding” of which the type is a QName. This description is enriched via the attribute 166 “xsdenc:type” to add that this attribute is a reference of simple type. The type and the name of the component are furthermore indicated, via the attributes 167 “xsdenc:targetType” and 168 “xsdenc:targetID”.

FIG. 5 represents an example 170 of annotation to specify that a use of qualified name is of component reference type. The type of link is, moreover, indicated via the attribute 171 “xsdenc:targetType”: this is an enrichment/addition link. This information may be used by a binary XML coder to compress the referencing component on the basis of the referenced component.

These items of link information are next advantageously used by the new applications to:
code a document more efficiently (see FIGS. 7 and 8),
efficiently select a self-descriptive subset of components (see FIG. 9) in a particular document and/or
process the documents more efficiently.

FIG. 6 represents, in the form of a logigram, the general use of these items of information. This logigram is, in FIGS. 7 to 9, particularized for two applications: efficient coding, FIGS. 7 and 8, and selection of a self-descriptive subset, FIG. 9.

In FIG. 6, commencement is made of the processing of a document at step 100 during which there is added an extension schema to the computer system, and a document schema enrichment during which addition is made to the document schema, at the level of the definition of a root element of the language of:
what a component is,
   where the inclusion mechanisms and their associated namespace are,
   where the namespace URI is of the document,
      then, for each use of the qualified name type:
whether it is a reference, and if yes, its type and its target.

During step 100, a client sends a request to the computer system, said request specifying to the computer system the name of at least one component to retrieve and/or the name of the document, and the operations are carried out of the reception of the request by a computer system, the retrieval of an XML or Binary XML data stream to process corresponding to the request received and the enrichment of the document.

Next, during a step 105, a search is made to determine whether there is a component to process in the document. If yes, during a step 110, the references in the component to process are searched for. If there are references in the component to process, during a step 115, the components referenced by those references and their positions in the document are retrieved. Next, during a step 120, recursive application is made of the steps illustrated in FIG. 6 in order, for example, to select a self-descriptive subset of components, as set forth with respect to FIG. 9 or to perform coding of the components, as set forth with respect to FIGS. 7 and 8.

Step 125 consists in the processing, as such, of the data of the component. This involves, for example, making a copy of the representation of the component in another document in the case of the selection of a self-descriptive subset of components (see FIG. 9). It may also be the coding in Binary XML of the data of the component (see FIGS. 7 and 8), including the references, using the information determined during step 115 and/or 120.

Next, during a step 130, the next component is selected and step 105 is returned to.

In case it is determined during step 105 that there is no further component to process in the document, the end of the actual processing is carried out during a step 135. For example, this step 135 consists of using the result of the processing for a particular application: storage of the document or sending of the document over a network for example.

In the case of the coding, illustrated in FIG. 7, the aim is to use the information available in the schema to better code the document. There are different proposals for more efficiently coding an XML document on the basis of its schema, for example “Fast Schemas”, “Fast Infoset” or BiM (registered trademarks). The steps illustrated in FIG. 7 may be based on one of the examples cited above, or on any other binary coding.

During a step 200, addition is made of an extension schema to the computer system, and a document schema enrichment is carried out during which addition is made to the document schema, at the level of the definition of a root element of the language, of:
what a component is,
where the inclusion mechanisms and their associated namespace are,
where the namespace URI is of the document,
   then, for each use of the qualified name type:
whether it is a reference, and if yes, its type and its target.

During step 200, a client sends a request to the computer system, said request specifying to the computer system the name of at least one component to retrieve and/or the name of the document, and the operations are carried out of the reception of the request by a computer system, the retrieval of an XML or Binary XML data stream to process corresponding to the request received and the enrichment of the document, the coding of the start of the document and the retrieval of the first component of that document. According to the type of binary coding, it is possible, during step 200, to add a start and/or end of component marker. This marker may be implicit as end of an element of depth 1 (that is to say that the direct ascendant of that node is the root node of the document).

For the first component or, during the following iterations, for the current component, during a step 205, determination is made of whether a component to code remains. If not, step 235 is proceeded to.

If there remains a component to code, determination is made during a step 210 of whether the first component remaining to code comprises a reference of QName type. To that end, a search is made of whether the component has an item of data of QName type to code and the additional information of the schema is used to determine whether it is a reference.

If it is not a reference, coding is made in conventional manner during a step 220 of that QName in the form of a string, in token form, or in a more optimized form representing the local name and a prefix or a namespace.

If the component to code comprises a reference of QName type, coding is made during a step 215 of that QName in the form of a direct reference to the component pointed to. This reference may be a pointer in the bitstream, which is useful, in particular, in the case of positionable data streams such as in file systems. This reference may also be a simple number incremented at each new component.

After one of the steps 215 or 220, processing is carried out of the other data of the component, during a step 225. The coding of these data depends on the presence of a reference and on its type, for example “simple” type or “enrichment” type, as specified in FIG. 8. Next, during a step 230, the next component is selected and step 205 is returned to.

As a variant, the retrieval is first of all made of all the components to process and, then, the processing steps 210 to 225 described above are carried out, on each of the retrieved components.

Once all the components have been coded, the coding is finished and, during a step 235, the document is transmitted in order for it to then be used, step 240, more efficiently than a document of the prior art.

In some embodiments, the coding is carried out while keeping in memory the binary representations of the components and their position in the data stream and a data stream is sent containing only the components selected during the step 210.

In the case of a coding in binary extended markup language, the qualified names of reference type are coded during the coding step 235 as a pointer to another component. For example, said pointer is coded in the form of a position in the data stream expressed in bits or in the form of a position of the component in a list. In some embodiments, during the coding step 235, an item of information of enrichment link type is implemented to compress the referencing component on the basis of the referenced component. In some embodiments, during the coding step 235, the qualified names of at least one type other than the reference type are coded by separating a local name from the prefix by a namespace.

FIG. 8 details the steps 215 and 225 of FIG. 7, in particular in the case of the coding of a component in terms of difference relative to the basic component. Where the component is of simple type, step 315 corresponds to step 225.

During a step 305, it is determined whether the reference is of “simple” type. If yes, during a step 310, the position of the item referenced in the data stream is coded then, during a step 315, the other data of the component are coded.

Otherwise, during a step 325, it is determined whether the reference is of data “enrichment/addition” type. If yes, coding is carried out during a step 330 of the position of the referenced item in the data stream in similar manner to that carried out during step 310 then, during a step 335, the differences in data between the component and the referenced component are calculated and coded in the data stream. This mechanism is, of course, extensible. If the reference is not of “enrichment/addition” type, another coding is carried out during a step 340, of type known to the person skilled in the art, then, during a step 345, the other data of the component are coded.

Further to one of the steps 335 or 345, the coding of the component is completed.

The coding presented uses an XML Binary coding. It is to be noted that it is also possible, though less efficient, to code the reference information in XML via an attribute, if the addition of an attribute is possible by the basic language. The size of the document is then increased in exchange for an improvement in the processing speed.

FIG. 9 illustrates a succession of steps for selecting a self-descriptive subset of components.

The applications are, often, better adapted to process only one component from a set of components, in a document. To use that component, the application must generally know the set of the components that are referenced, directly or indirectly, by that component. The algorithm illustrated in FIG. 9 makes it possible to retrieve such a subset of components and exploits the method of the present invention, as presented above, to improve its efficiency.

During a step 400, the processing is commenced by an addition of an extension schema to the computer system, and a document schema enrichment during which addition is made to the document schema, at the level of the definition of a root element of the language, of:
what a component is,
where the inclusion mechanisms and their associated namespace are,
where the namespace URI is of the document and/or
for each use of the qualified name type, whether it concerns a reference, its type and its target.

During step 400, a client sends a request to the computer system, said request specifying to the computer system the name of at least one component to retrieve and/or the name of the document, and the operations are carried out of the reception of the request by a computer system, the retrieval of an XML or Binary XML data stream to process corresponding to the request received and the enrichment of the document. Then, during a step 405, the component searched for by the application is retrieved from the data stream. During a step 410, the processing of that component is started by adding, to a list Lr, the references of that component to unprocessed components.

Preferentially, to limit the memory positioning number, the list Lr is put in order according to the reference: the closer the reference points to the start of the data stream, the closer it is to the start of the list Lr.

The detection of the references is carried out via the annotated schema if the document is in XML. If the basic document is in binary XML, the information of the annotated schema is not necessarily useful, in particular when the binary format specifies the type of the data, that is to say if the binary stream specifies that a particular item of data is of QName reference type.

During a step 415, determination is made of whether a reference remains in the list Lr. If not, step 445 of using the components is proceeded to. If yes, during a step 420, it is determined whether the first reference remaining in the list Lr is an internal reference of the document. Otherwise, the appropriate importation mechanism is used during a step 440. This may for example be a matter of going to retrieve another document and of processing it in the same way as the first document.

If the first reference remaining in the list Lr is an internal reference, that reference is used during a step 425 to position the data stream. Next, during a step 430, the referenced component is processed and, during a step 435, the references of that component are added to the list Lr.

Further to one of the steps 435 and 440, the step 415 is returned to, eliminating the reference which has just been processed from the list Lr.

Preferentially, during the retrieval of a description of each referenced component, the computer system may know that some components are already known by the client who sent the request, in which case, the referenced component may be processed like the external references, so making it possible not to send those components several times.

It is to be noted that the algorithm illustrated in FIG. 9 is easily extensible to the search for several components. It is also to be noted that technologies exist making it possible to identify components within documents (via “XPointer” a W3C recommendation (or standard) which may be found at the following address: http://www.w3.org/TR/xptr/).

Thus it is possible to request retrieval of a component specified by its name, for example “MyService”, of WSDL service type in a given document. In the prior art, if such a request is sent to a generic server, the latter sends back the whole document. By virtue of the implementation of the teaching of the invention given in relation to FIG. 9, the server in question may automatically send back the document containing only the component “MyService” and the associated components. One of the advantages of this implementation is that the server does not have to know the document type precisely. The improved schema is the only information necessary for the server. In this particular case, the importation mechanism of step 440 consists of including, in the data stream to send, the importation components corresponding to the external references necessary for the desired component.

It is furthermore possible to combine the selection algorithm, illustrated in FIG. 9, with the coding algorithm illustrated in FIGS. 7 and 8. In some embodiments, the coding is carried out during the step 445, while keeping in memory the binary representations of the components and their position in the data stream and a data stream is sent containing only the components selected during the step 415 and 420.

In the case of a coding in binary extended markup language, the qualified names of reference type are coded during the coding step 445 as a pointer to another component. For example, said pointer is coded in the form of a position in the data stream expressed in bits or in the form of a position of the component in a list. In some embodiments, during the coding step 445, an item of information of enrichment link type is implemented to compress the referencing component on the basis of the referenced component. In some embodiments, during the coding step 445, the qualified names of at least one type other than the reference type are coded by separating a local name from the prefix by a namespace.

To solve the problem of the references which are no longer correct in the new data stream, in some embodiments, the references are updated with the new data stream. In other embodiments, a table is included making it possible to match the old references and the positions in the new data stream. In other embodiments, position indicators are included in the data stream making it possible to mark a jump in the positioning of the data stream, in the case in which a component of the original data stream has been removed during the selecting step: the component is not transmitted, but instead a position jump indicator with the size of the component is transmitted. This position jump indicator enables the processor to easily update its position indicator.

FIG. 10 represents implementation steps of a decoding algorithm which uses the coding presented with reference to FIGS. 7 and 8. This involves retrieving a component as well as the components that are directly or indirectly referenced by that component from a Binary XML data stream. During a step 500, the processing is started by decoding the information of the principal node. Next, during a step 505, the first component is selected. During a step 510, it is determined whether the information of the selected component contains a reference to an unknown component, that is to say a component not yet processed. If not, step 530 is proceeded to. If yes, it is determined during a step 515 whether it is a case of an internal reference. If not, that is to say that it is a case of an external reference, the link information is used to retrieve the data stream and the place in the data stream containing the information of that component, during a step 525.

If it is an internal reference, the link information is used during a step 520 to go directly to the information of the referenced component in the same data stream. During the processing of that component, if references are found, those references are then processed recursively by applying the same principle starting with step 505. A reference/component matching table furthermore makes it possible to retrieve the components that have already been processed. After one of the steps 520 or 525, or if the result of the step 510 is negative, determination is made during a step 530 of whether at least one component remains to be processed. If yes, a component is selected and step 510 is returned to. The processing is continued in this manner until the components used by the application have been retrieved. The algorithm set forth with reference to FIG. 10 may also apply to the case in which the document is transmitted in XML with the reference information added in XML.

If the result of step 530 is negative, the processed components are used during a step 535.

Alternatively, the processed components may be progressively supplied to the client application.

It is to be noted that depending on the binary XML coding chosen, the decoding does not necessarily require the knowledge of the annotations added to the schema, in particular when the type of value is included in the data stream for each value, as is the case for Fast Infoset.

Where it is desired to retrieve all the components, it is judicious to process the data stream linearly. In this case, the qualified name coded in the form of a reference enables a more efficient resolution of the reference than the qualified name coded in the form of a string since it is faster to retrieve a component on the basis of an index/pointer than on the basis of a qualified name, which includes retrieval of the namespace on the basis of the prefix, then two comparisons of strings, representing the name and the namespace, as well as a comparison of the type of the qualified name.

On decoding, in particular in the case in which the client and the server can communicate rapidly, it is possible for a client to request a particular component again using the reference of the component directly. This enables the server to retrieve the component more easily than on the basis of the qualified name and the type of the component. This possibility is in particular useful when the client is, for some reason, unable to retrieve a component from a data stream, for example when the data stream is not backwardly repositionable. This case applies in particular when the protocol used is of streaming type (RTP, acronym for “real time transport protocol”, see the recommendation RFC 3550). In this case, the reference of the component may include the number of the packet in which the description of the component is to be found.

As set forth above, on sending a request, the client sends the name of the component to retrieve and/or the name of the document. On reception of such a request, the server:
retrieves the description of the component searched for and the set of the references of that component, determined via the enriched XML schema;
retrieves the description of each referenced component;
reiterates these two steps until a self-descriptive set of components has been obtained;
codes the description of the components in XML or Binary XML.

In the case of XML binary coding, the qualified names of reference type are coded as a pointer to another component and not as strings. This pointer may be coded in different ways: it may be a position in the data stream, expressed in bits. It may also be expressed in the form of the position of the component in a list: “1” if it is the first component in the data stream, “2” if it is the second, and so forth. The advantages of a pointer are double: it enables more efficient coding of the information, as there are fewer bits to transmit, and it also enables more efficient processing of the components by facilitating the resolution of those references. The other qualified names are coded in string form or another more efficient coding separating the local name from the prefix or namespace.

By inserting this information in the XML schema, it is furthermore easy to upgrade the system managing the documents, typically a file server:
functionalities may be added by adding an annotated schema to the system. For example the XS schema (XS being an acronym for “XML Schema Language”, which is a W3C recommendation. This language makes it possible to describe XML document templates) and the schemas WSDL, Relax NG. This is another XML schema language for XML documents, standardized by the ISO), WS-Addressing (acronym for “web service addressing”. This is a W3C recommendation which describes how to route SOAP messages over a network.
for this type of language, extensions are often created. These extensions may add references between components. To add the support for an extension to a language, it suffices once again to add the schema of that extension to the system (WSDL Extension such as http binding, for example).

FIG. 11 shows particular embodiment of the device 600 of the present invention and different peripherals adapted to implement each aspect of the present invention. In the embodiment illustrated in FIG. 11, the device 600 is a micro-computer of known type connected to a means for acquiring or storing XML code.

The device 600 comprises a communication interface 618 connected to a network 634 able to transmit, as input, digital data to process and, as output, data processed by the device. The device 600 also comprises a storage means 612, for example a hard disk, and a drive 614 for a diskette 616. The diskette 616 and the storage means 612 may contain data to process, processed data and a computer program adapted to implement the method of the present invention.

According to a variant, the program enabling the device to implement the present invention is stored in ROM (read only memory) 606. In another variant, the program is received via the communication network 634 before being stored.

The device 600 is, optionally, connected to a microphone 624 via an input/output card 622. This same device 600 has a screen 605 for serving as an interface with the user for parameterizing certain operating modes of the device 600, using a keyboard 610 and/or a mouse for example.

A CPU (central processing unit) 603 executes the instructions of the computer program and of programs necessary for its operation, for example an operating system. On powering up of the device 600, the programs stored in a non-volatile memory, for example the read only memory 606, the hard disk 612 or the diskette 616, are transferred into a random access memory RAM 608, which will then contain the executable code of the program of the present invention as well as registers for storing the variables necessary for its implementation.

Naturally, the diskette 616 may be replaced by any type of removable information carrier, such as a compact disc, memory card or key. In more general terms, an information storage means, which can be read by a computer or microprocessor, integrated or not into the device, and which may possibly be removable, stores a program of the present invention. A communication bus 602 affords communication between the different elements included in the device 600 or connected to it. The representation, in FIG. 11, of the bus 602 is non-limiting and in particular the central processing unit 603 unit may communicate instructions to any element of the device 600 directly or by means of another element of the device 600.

The device described here and, particularly, the central processing unit 603, may implement all or part of the processing operations described with reference to FIGS. 1 to 10, to implement each method of the present invention and constitute each device of the present invention.

1. A method of processing a document in a computer system, comprising:
enriching a schema of the document to separate qualified names used to reference components and qualified names used to reference defined semantic; and
detecting components referenced in the document using the enriched schema obtained in advance.

2. A method according to claim 1, further comprising adding information to the schema in order to detect, in the case of references to components, the position of the components referenced in the document.

3. A method according to claim 1, further comprising sending a request during which a client sends the name of at least one component to retrieve and/or the name of the document to the computer system.

4. A method according to claim 3, wherein, on reception of said request, and until a self-descriptive set of components is obtained, said computer system iteratively performs:
a step of retrieving the description of the component searched for and the set of the references of that component, said references being determined according to the schema of the enriched document; and
a step of retrieving a description of each referenced component.

5. A method according to claim 4, wherein said computer system furthermore performs, after at least one said iterative step, a step of coding the description of at least one component in extended markup language, which may be binary.

6. A method according to claim 1, further comprising a step of coding in binary extended markup language, during which the qualified names of reference type are coded as a pointer to another component.

7. A method according to claim 6, wherein, during the coding step, said pointer is coded in the form of a position in the data stream expressed in bit form.

8. A method according to claim 6, wherein, during the coding step, said pointer is coded in the form of a position of the component in a list.

9. A method according to claim 5, wherein, during the coding step, an item of information of enrichment link type is implemented to compress the referencing component on the basis of the referenced component.

10. A method according to claim 5, wherein, during the coding step, the qualified names of at least one type other than the reference type are coded by separating a local name from a prefix by a namespace.

11. A method according to claim 1, further comprising a step of adding an extension schema to the computer system.

12. A method according to claim 1, wherein during the step of enriching of the document schema, addition is made to the document schema, at the level of the definition of a root element of the language, of:
what a component is,
where the inclusion mechanisms and their associated namespace are,
where the namespace URI is of the document and/or
for each use of the qualified name type, whether it concerns a reference, its type and its target.

13. A document processing device comprising:
a unit configured to enrich a schema of the document to separate qualified names used to reference components and qualified names used to reference defined semantics; and
a unit configured to add information to the schema in order to detect, in the case of references to components, the position of the components referenced in the document.

14. (canceled)

15. (canceled)

16. A computer-readable storage medium that stores a program for instructing a computer to implement the processing method according to claim 1.

17. (canceled)

18. A device according to claim 13, further comprising a unit configured to add information to the schema in order to detect, in the case of references to components, the position of the components referenced in the document.

19. A device according to claim 13, further comprising a unit configured to send a request representing the name of at least one component to retrieve and/or the name of the document to the computer system and a unit configured, on reception of said request, and until a self-descriptive set of components is obtained, to iteratively:
retrieve the description of the component searched for and the set of the references of that component, said references being determined according to the schema of the enriched document; and
retrieve a description of each referenced component,
and, after at least one said iteration, code the description of at least one component in extended markup language, which may be binary.

20. A device according to claim 13, further comprising a unit configured to code in binary extended markup language the qualified names of reference type as a pointer to another component, wherein, said pointer being coded in the form of a position in the data stream expressed in bit form or in the form of a position of the component in a list.

21. A device according to claim 19 wherein the unit configured to code codes the qualified names of at least one type other than the reference type by separating a local name from a prefix by a namespace.

22. A device according to claim 13, further comprising a unit configures to add an extension schema to the computer system.

23. A device according to claim 13, wherein the unit configure to enrich the document schema is configures to make addition to the document schema, at the level of the definition of a root element of the language, of:
what a component is,
where the inclusion mechanisms and their associated namespace are,
where the namespace URI is of the document and/or
for each use of the qualified name type, whether it concerns a reference, its type and its target.
